(19) United States
(12) Patent Application Publication
(10) Pub. No.: US 2005/0266887 A1
(43) Pub. Date: Dec. 1, 2005

(54) Stationary non-mobile cellular telephone terminals

(76) Inventor: Nahla Fouad Elmenayer, Northport, NY (US)

Correspondence Address: NAHLA FOUAD ELMENAYER, 23 BEACH HILL DRIVE, FORT SALONGA, NY, 11768, US

(21) Appl. No.: 11/101,692

(22) Filed: Apr. 8, 2005

Related U.S. Application Data
(60) Provisional application No. 60/575,648, filed on May 29, 2004.

(30) Foreign Application Priority Data
Feb. 22, 2005 (WO) PCT/US05/05365

(51) Int. Cl. H04M 1/00

(52) U.S. Cl. 455/561

(57) ABSTRACT

This invention will place the cellular components of the hand held cellular mobile phones mainly (the antenna, receiver and the transmitter) in the base of traditional desktop phone apparatus. That makes a stationary non-mobile cellular telephone that that looks like traditional desktop phone but can use the cellular phone network instead of the ground hardwire telephone network connection. Since the Antenna and transmitter are away from the handset, the user will be exposed to no radiation hazard. The stationary non-mobile cellular telephone has a base station apparatus and a handset that is hardwired-connected to the base station apparatus. The stationary non-mobile cellular telephone base station apparatus will house the cellular components that are needed to communicate with the cellular telephone network. These components are mainly the antenna, receiver, transmitter and a CPU unit. This will eliminate any radiation hazard to the person talking through the handset The stationary non-mobile cellular telephone unit is desktop, wall mounted or both. The stationary non-mobile cellular telephone unit can be vehicle mounted. The stationary non-mobile cellular telephone unit is powered through regular electric outlet, with or without volt transformer. The stationary non-mobile cellular telephone unit can have a back up power source battery either rechargeable or disposable. The stationary non-mobile cellular telephone unit is used to receive and place phone calls any place where cellular wireless reception is available. The stationary unit can be easily combined and integrated with many other devices including but not limited to (Alarm clock, AM/FM Radio receiver, Facsimile device-Fax machine, Answering machine, Credit card machine, Camera, Computer, Television unit). A display screen allows the user to display graphic information such as facsimile data pictures etc. The subsystems are prioritized such that one system is automatically interrupted based on higher priority activity.

This application claims the benefit of U.S. Provisional Application Provisional patent application No. 0/575648 dated May 29, 2004 And International applications (PCT) # PCT/US2005/005365 dated Feb. 22, 2005 designating the United States of America

### TECHNICAL FIELD

Available cellular mobile phones pose health hazards to the user as the radiation from the antenna, receiver, transmitter are placed against the ear of the user, and when placed in the left shirt pocket, its signal my affect the cardiac rhythm and any inserted pace maker.

Currently all Cellular-Mobile phones are mobile, small sized, hand held or head worn phone apparatus. The user carries them along from home to car Technical field to work. Any place where wireless cellular signals reach, they can be used. However, it can be easily misplaced, forgotten, lost, or stolen.

The Stationary non-Mobile Cellular Telephone configures the cellular components of mobile phones in a non-mobile stationary conventional telephone format that is placed on desks or mounted on wall. Since the antenna, receiver and transmitter are placed in the base of the telephone unit and away from the handset, using the handset or speaker to carry on a phone conversation is associated with no radiation hazard compared to the hand held mobile cellular phone units.

The user can go to store pick a stationary cellular phone unit that suits his needs and subscribe to the cellular phone service in the same place, the service will be activated immediately and the user will be provided with a telephone number that is assigned to his stationary non mobile cellular apparatus. The user can go to his home or office and places the phone on his night table or desk and immediately use the phone service available to him.

The user can move the unit from room to room, from building to building or town to town without having to call the telephone company anymore.

With the new laws, if the user buys another telephone apparatus to replace the one he has he can keep the same phone number. This feature will make it very attractive for business to use the non-mobile stationary cellular phone apparatus because their customers will have the same business numbers.

These units will be used at homes and businesses even in buildings that have conventional landlines. It allows increased consumer choice between telephone companies operating the landlines and telephone companies offering cellular wireless service in the area.

The stationary non-mobile cellular telephone is left in the place of use like work or home. But it can be easily moved from room to room without the need of phone wire jacks in that location.

My invention, the stationary non mobile apparatus will allow a user who lives in an area covered with wireless service to buy a unit, activate the service, picks the handset place and receive calls whether at home or work without having to connect to a phone jack. He can turn the answer machine on, it will pick up all the incoming calls, when he is ready he plays his messages.

If the incoming calls are from a fax, if the unit is equipped with a fax machine, it will automatically receive the fax and store or print it.

If during work the user wants to listen to the news, he turns the radio on.

The user can program the stationary non mobile phone alarm to alert him at any certain time.

If the stationary non-mobile cellular phone is equipped with credit card machine, he can sweep the card or manually put the credit card information and the machine will process the transaction using cellular, mobile wireless services.

Regular telephone apparatus are available on the market; they are bulky and hard to carry around. Regular telephone apparatus represents no radiation hazards compared with the mobile cell phones The user connect them to a telephone jack in a certain place, like on desk, night table next to bed or mounts them on the kitchen wall.

The user doesn't lose them and run around looking for them everywhere. However, regular telephone apparatus require a ground hard wire connection to telephone network. In order to have a telephone line, the users usually have to call the telephone company and put a request for a phone line, the telephone company assign user a telephone number and send a technician to make a connection from the telephone pole or cable that go to the building and from there to the desired room. The user then plugs the phone apparatus to the provided jack and uses the service. If the person wants to move the phone apparatus to another side of the room or even to another floor of the building he will have to extend a wire from the telephone jack to the new location. If the user moves to the other side of town, he had to call the phone company that either forward the phone line to the new location or assign him a new different telephone number. This usually costs the user a bundle of money. On the other hand, any part of the world where cellular wireless signals are available, the stationary non-mobile cellular phone can be moved to and used immediately.

Any kind of power source can be used to operate the unit.

### BACKGROUND OF INVENTION

Traditionally telephone networks have relied upon millions of miles of wire strung between points to affect such communications. Improvements in such “wired” communication have been fiber optic links and other wideband links that rely upon the physical connection between points.

A further factor driving the world toward cellular telecommunications is the fact that with wired communications, in the event of an interruption in the communication services, a service vehicle must be sent to inspect literally the entire communications path over miles of wires in the event that the problem can not be traced directly to the subscriber's or the telephone operator's equipment. Having such a work force and service fleet “on call” is an expensive venture and results in very large maintenance costs associated with maintaining high quality communications over wire links. Further, the maintenance of wired communication links is an expensive prospect requiring various types of wires or fiber optics as well as the physical facilities for maintaining these wires either on poles or buried in conduits throughout the countryside.

Despite this technological marvel, the telephone has not reached many parts of the world where large distances would require stringing many more miles of wire to serve locations that might prove to be of dubious commercial value. In short, in many rural areas of the United States and in many third world countries telecommunications over wire links have failed to develop or have developed slowly at best.

The telephone companies are spending a lot of money to maintain the phone line wires. In order to have a telephone line, the users usually have to call the telephone company and put a request for a phone line, the telephone company assign user a telephone number and send a technician to make a connection from the telephone pole or cable that go to the building and from their to the desired room The user then plugs the phone apparatus to the provided jack and uses the service.

If the person wants to move the phone apparatus to another side of the room or even to another floor of the building he will have to extend a wire from the telephone jack to the new location. If the user moves to the other side of town, he had to call the phone company that either forward the phone line to the new location or assign him a new different telephone number. On the other hand, any part of world where wireless signals are available, the stationary non-mobile cellular phone can be used.

Any kind of power source can be used to operate the unit.

Satellite communications have allowed telecommunications to be extended to many parts of the world. However, such telecommunications still rely upon local wired networks of one form or another to allow communications via satellite to reach the individual homes or community once the down link to a ground station has been made. Again, there can be substantial burdens in both geography and finances to allow such telecommunications to take place.

Cellular telecommunications offers tremendous advantages over the stringing of miles of wire through inhospitable countryside. With such cellular telecommunications a reception and repeating towers is needed in order for communications to be established from one point to another.

An additional advantage of cellular telecommunications is that there is a significant cost savings of installing the infrastructure since wires no longer needed to be installed throughout the countryside. Further, the cost of such terminals has been decreasing dramatically over the years such that many countries are now taking a technological “leap frog” approach to establishment of a telephone communication infrastructure by simply moving directly to wireless networks without even worrying about installing wires.

Cellular telecommunications is clearly an attractive solution for telecommunications in rural and remote areas as well as in areas that are underdeveloped or have no telephone infrastructure whatsoever. Wireless telecommunication also offers significant savings in installing and maintaining the telecommunications infrastructure since only base stations (Towers) and signal repeating stations (Towers) if necessary must be maintained as opposed to many hundreds or thousands of miles of wire.

### SPECIFICATIONS AND DESCRIPTION

My invention, the stationary non mobile apparatus will allow a person lives in an area covered with wireless service can buy a unit plug it to a power source, picks the handset place and receive calls whether at home or work without any radiation hazards. He may turn the answer machine on, it will pick all the incoming calls, when he is ready he plays his messages.

If the incoming calls is from a fax, if the unit is equipped with fax machine it will automatically receive the fax store or print it. If during work he wants to listen to the news, he turns the radio on, He can program the machine alarm to alert him at any certain time. If the machine is equipped with credit card machine, he can sweep the card or manually put the credit card information, the machine will process the transaction using cellular, mobile wireless services.

### DESCRIPTION OF THE PRIOR ART

Numerous audio and video communication devices have been provided in the prior art. For example, U.S. Pat. No. 4,715,059; 4,932,047; 4,985,911, and 5,191,601 all are illustrative of such prior art. While these units may be suitable for the particular purpose to which they address, they would not be as suitable for the purposes of the present invention as heretofore described.
U.S. Pat. No. 6,850,780
Gioscia, et al. Feb. 1, 2005
   Compact Palmtop Computer System and Wireless Telephone with Foldable Dual-Sided Display

The invention is a compact personal digital assistant (PDA) and cellular telephone with foldable dual-sided display. By utilizing flexible display technology, both a PDA and a cellular telephone are incorporated into one device. In a closed state, in one embodiment, the present invention corresponds to the form used for typical cellular telephone use (e.g., candy bar size). In an open state, in one embodiment, the present invention corresponds to the form used for typical PDA use by providing an enlarged viewing area. The present invention provides the benefit of two distinct devices in one device by allowing for common operations and functionality without compromising the respective form factor of either device.
Inventors: Gioscia; Rich (Santa Clara, Calif.); Canova, Jr.; Francis J. (Fremont, Calif.)
Assignee: PalmOne, Inc. (Santa Clara, Calif.)
Appl. No.: 764018
Filed: Jan. 16, 2001
U.S. Pat. No. 4,715,059

Inventor: Michael A. Cooper Hart et al. Dec. 22, 1987 the invention is a conversational freeze-frame videophone, which transmits a source image over a standard telephone line in conjunction with audio voice signals.
U.S. Pat. No. 5,819,177
Vucetic, et al. Oct. 6, 1998

Fixed wireless terminals with network management method and apparatus
U.S. Pat. No. 5,799,254
Karmi, et al. Aug. 25, 1998

Method and apparatus for providing a dial tone to a telephone within a wireless local loop system the user is provided with a telephone handset similar in size, shape and operation to a conventional telephone handset (i.e. one connected to a PSTN). However, rather than being connected to a PSTN line, the telephone handset of the wireless local loop system is connected to, or includes, a wireless transmitter similar to those employed in conventional cellular telephones. In one implementation, the telephone handset is connected by wiring to a fixed wireless transmitter located nearby, perhaps on the roof of a building.
U.S. Pat. No. 4,932,047
Inventor: Lawrence. D. Emmons et al.
Issued: Jun. 5, 1990

An improved videophone transmits a source image over a standard telephone line in conjunction with voice signals.
Inventor: Lawrence. D. Emmons et al.
Issued: Jan. 15, 1991

An improved video phone which transmits a source image over a standard telephone line in conjunction with audio voice signals is disclosed circuitry are turned on and off by a switch coupled to panel which can be slid in front of the camera, thus providing for the automatic protection of the camera lens when the system is switched off.
Berland; Kerry S. (Chicago, Ill.)

A communication interface controller operable in conjunction with a two-way voice radio transceiver of the type operable from audio input signals and transmit control signals and providing audio output signals, and a facsimile transceiver including a telephone line interface for developing analog output signals and receiving analog input signals, said interface comprising:
U.S. Pat. No. 6,463,129
Park Oct. 8, 2002

Call screening method of a facsimile system having a stationary main unit connected to a telephone network and a cordless portable unit
U.S. Pat. No. 4,959,851
Tobolski, Jr., et al. Sep. 25, 1990

Dialing features for cellular telephone with standard telephone set a unique cellular telephone (100) connects to a standard telephone set (101) for providing cellular telephone services to subscribers in remote locations not served by a landline telephone system.
U.S. Pat. No. 6,463,129
U.S. Pat. No. 6,335,753
McDonald Jan. 1, 200

It wires connecting satellite transmission/receiver and originating videophone unit 34 telephone input jack for connection with satellite
U.S. Pat. No. 5,191,601
U.S. Pat. No. 5,983,073
Ditzik Nov. 9, 1999
   Modular Notebook and PDA Computer Systems for Personal Computing and Wireless Communications
   Abstract

A small lightweight modular microcomputer based computer and communications systems, designed for both portability and desktop uses. The systems make use of a relative large flat panel display device assembly (2), an expandable hinge device (10),
U.S. Pat. No. 5,983,073
Ditzik Nov. 9, 1999
   Modular Notebook and PDA Computer Systems for Personal Computing and Wireless Communications
   Abstract

A small lightweight modular microcomputer based computer and communications systems, designed for both portability and desktop uses. The systems make use of a relative large flat panel display device assembly (2), an expandable hinge device (10), battery power source (9), keyboard assembly (16), and wireless communications devices (32, 51). The systems are capable of bi-directional realtime communications of voice, audio, text, graphics and video data. Both wire-based or wireless communications methods and devices are implemented. Wireless communications devices may include one or more telephone-like handsets (14) and/or earset (34). The wireless communication devices may include one or more antennae (32). Systems can be configured in a portable arrangement similar to conventional notebook computers, but can be quickly and easily disassembled and re-assembled for office desktop uses. Systems may consist of a base computer unit (100) comprising wireless communication devices may act as a relay station relaying voice and other data between the handset or earset and external wide area communications networks. The system may be capable of performing, personal digital assistant (PDA), cellular telephone, conventional notebook computer, desktop computer functions.
U.S. Pat. No. 6,314,094
Boys Nov. 6, 2001
   Mobile Wireless Internet Portable Radio
   Abstract

An Internet-capable radio has a communication port for connection to a modem, a connection function for connecting to the Internet upon user initiation while connected to the modem, sound circuitry for rendering audio data packets received over the Internet as analog audio output, and for delivering the audio output to one or more speaker ports, two or more stored hyperlinks addressing Internet broadcast servers; and a user input adapted to enable a user to select among the stored hyperlinks. Selection of one of the stored hyperlinks by the user input invokes the hyperlink and connects the radio to the server addressed by the hyperlink, initiating thereby an audio data stream as data packets from the broadcast server to the radio, and wherein the radio renders the data stream as analog audio data delivered to the one or more speaker ports. The user input in preferred embodiments has a plurality of pushbuttons associated with hyperlinks, which can be asserted by activating a pushbutton.

A primary object of the present invention is to provide a cellular communication telephone system with a handset to eliminate radiation hazards to the user.

Another object of the present invention is to provide a cellular communication telephone system, which is able to transmit both audio and video signals through a cellular communications channel from stationary terminals.

A still further object of the present invention is to provide a cellular communication telephone system that will overcome the shortcomings of prior art devices.

Another object of the present invention is to provide a cellular communication telephone system that is simple and easy to Integrate with radio; fax machine, desktop computer, SPG device, antitheft device, clock, and credit card machine to allow them to function on cellular network.

Structure Characterized by

Base unit looks like desktop telephone or wall mounted telephone.

Base unit will house the Antenna, receiver, transmitter, CPU, memory needed for wireless communication. The Antenna might be attached to the base to avoid signal interference

Base unit may carry all the dialing features and necessary buttons for various telephone functions. It may have a speaker.

Base Unit has a cradle to carry the handset when it is not in use or when speaker is used.

The handset is hardwired to the base unit, where user can talk and listen with no radiation hazards.

The unit may be powered by attaching it to an electric outlet or through voltage transformer or rechargeable battery.

### DESCRIPTION OF DRAWIN

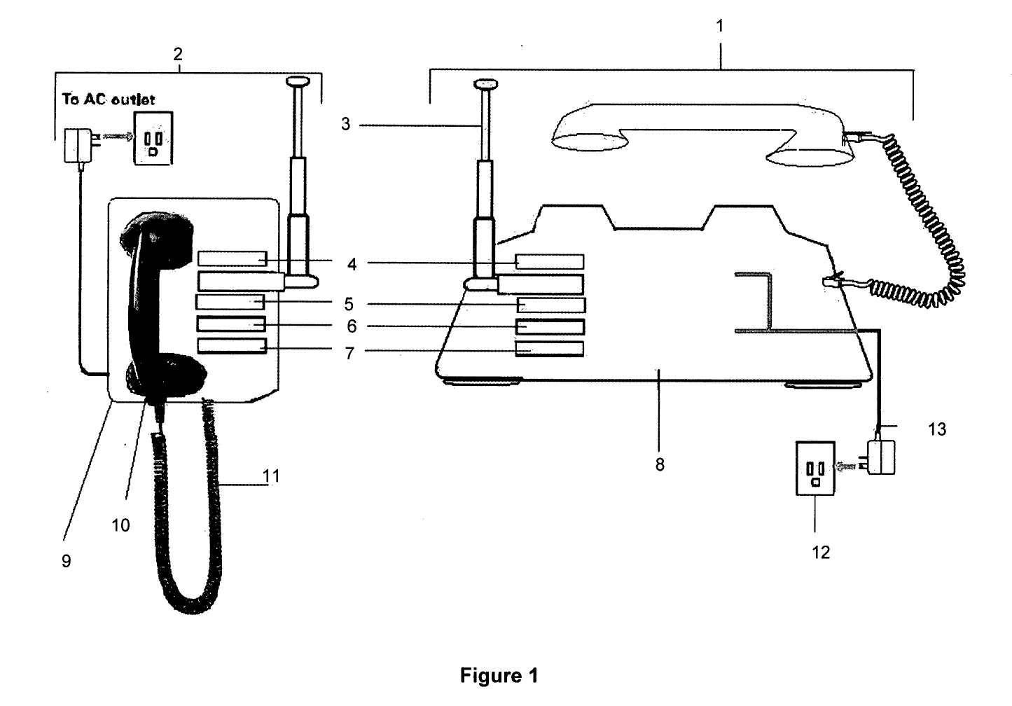

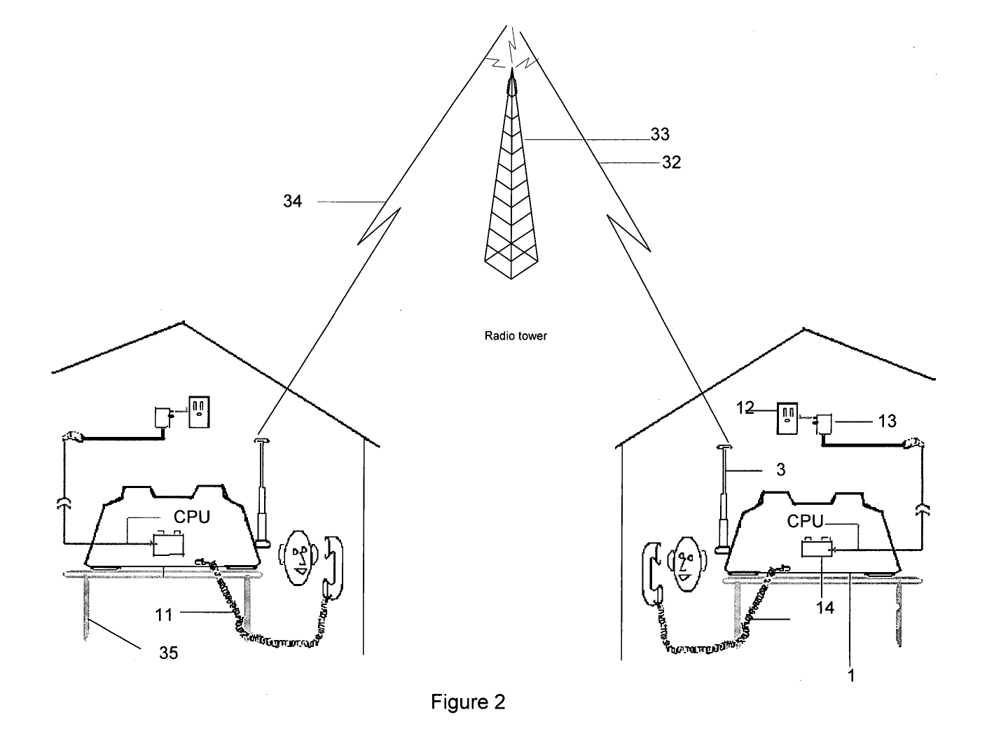

FIG. 1: provides for desktop and wall mounted stationary non-mobile cellular phones with the position of cellular antenna, transmitter and receiver away from hand set and details of electric outlet power source, possible transformer, and possible back up battery.

FIG. 2: provides for building with desktop stationary non-mobile cellular phone in use.

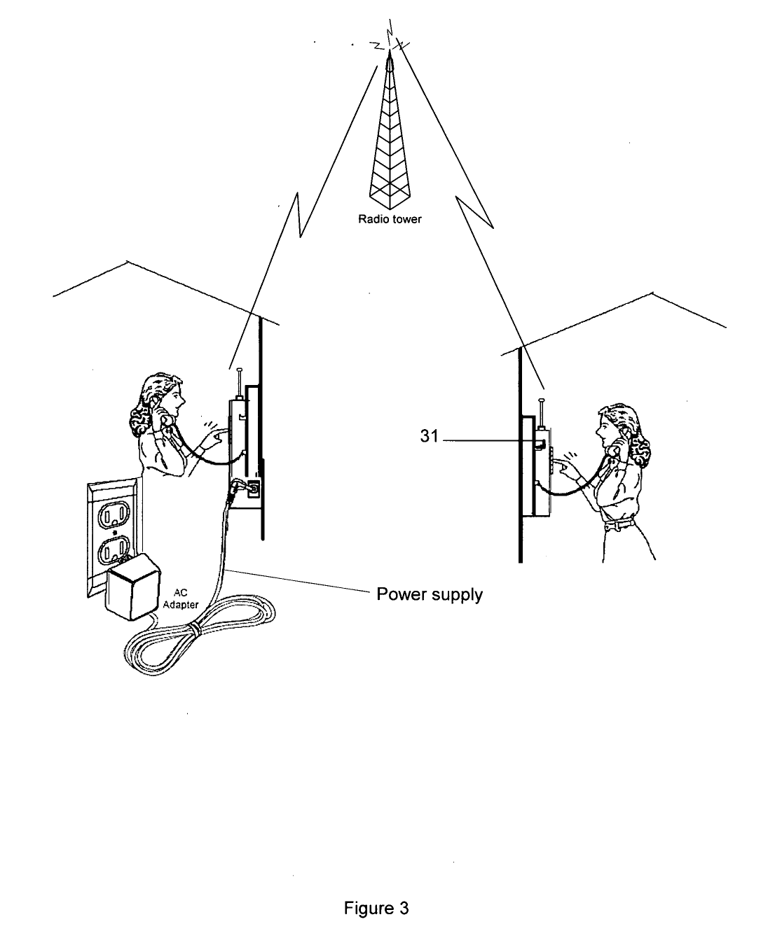

FIG. 3: provides for building with wall mounted stationary non-mobile cellular phone

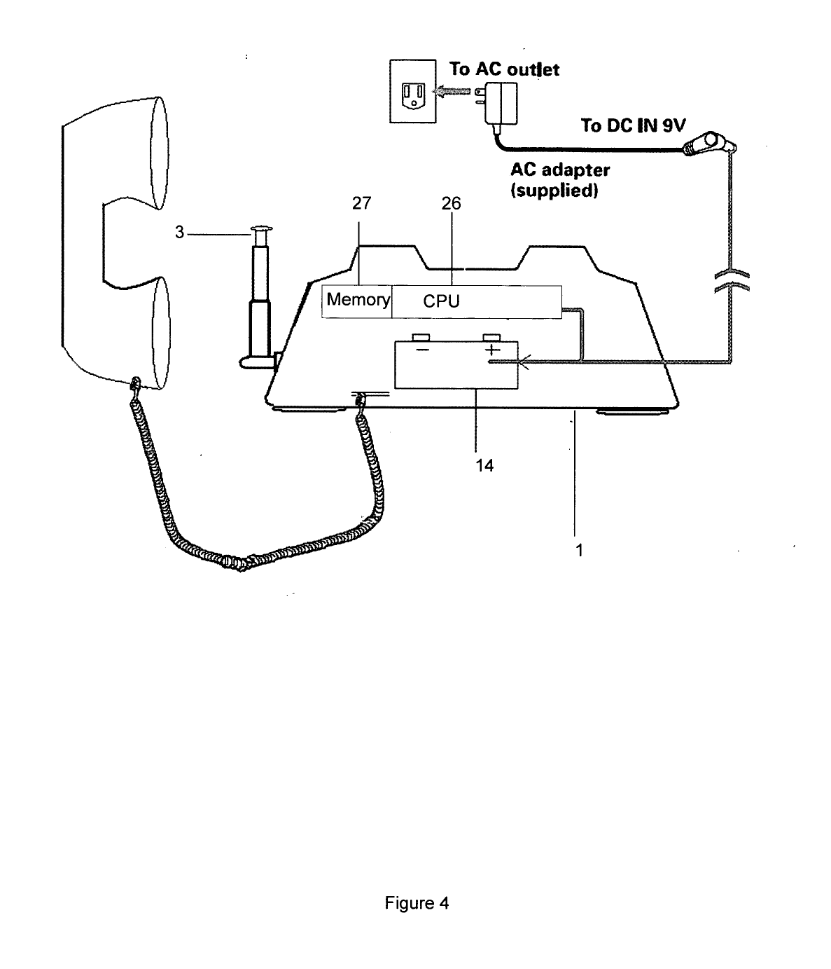

FIG. 4: provides for stationary non-mobile cellular telephone with regard to the power supply, rechargeable battery and handset hard wired to base unit of stationary non mobile cellular phone

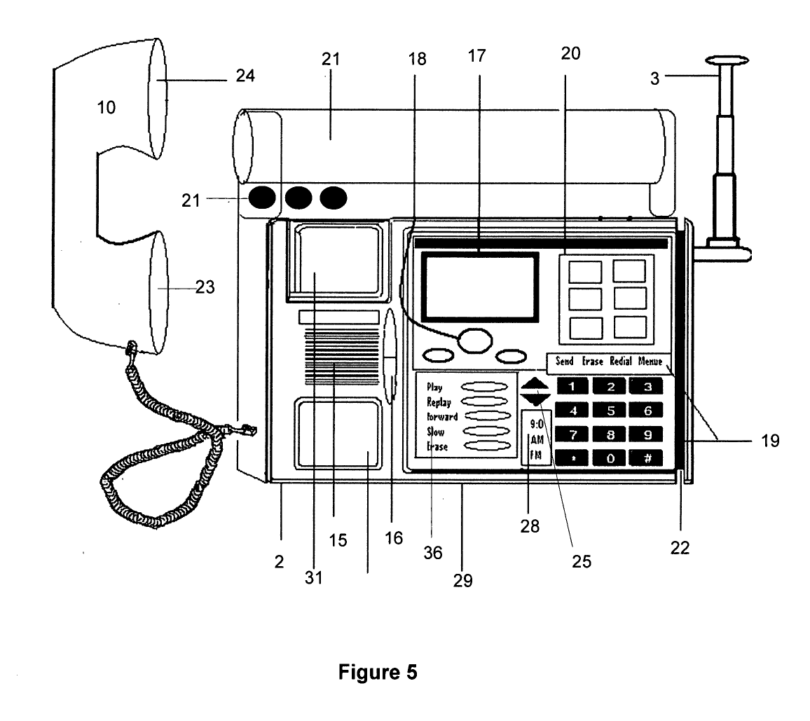

FIG. 5: provides for wall mounted stationary non-mobile cellular phones integrated with camera, clock with alarm, answering machine, fax machine, radio, antitheft and credit card machine.

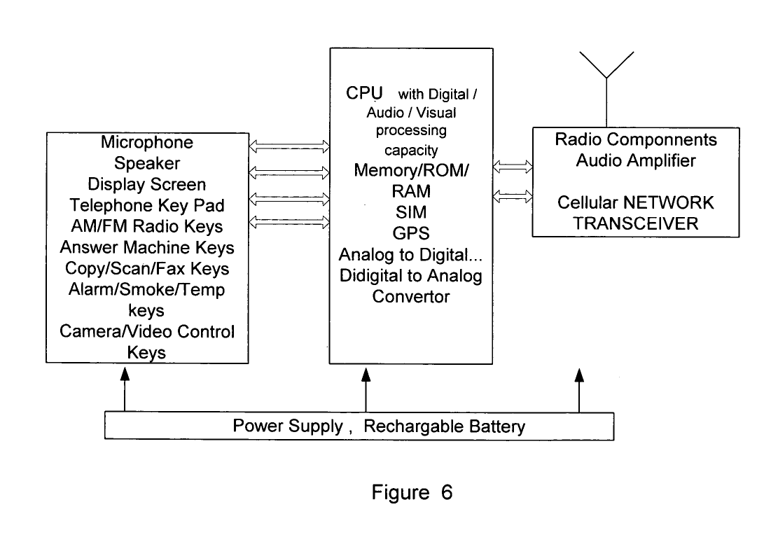

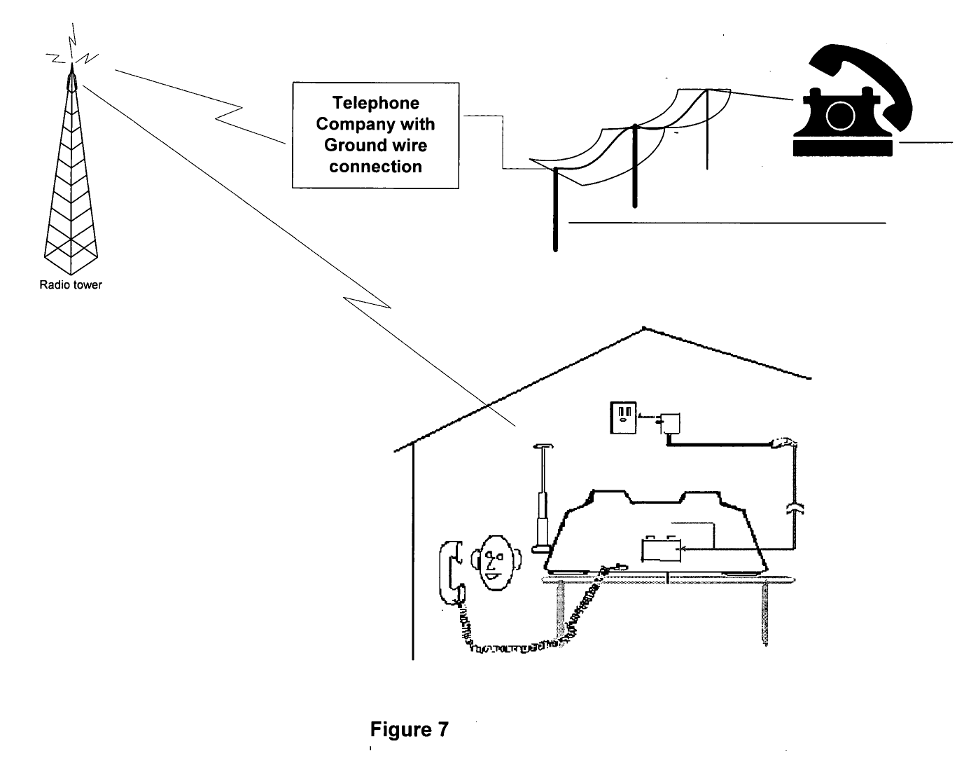

FIG. 6: Provides for over all schematic parts of stationary non-mobile cellular telephone unit.
1. Desktop stationary non-mobile cellular phones
2. Wall mounted stationary non-mobile cellular phones
3. Cellular Antenna
4. Cellular receiver
5. Cellular transmitter
6. CPU chip
7. Memory chip card
8. Base apparatus of cellular non mobile desktop phone
9. Base apparatus of cellular non mobile wall mounted phone
10. Handset
11. Cord connecting handset to telephone u
12. Electrical outlet
13. Electrical plug /transformer
14. Rechargeable battery
15. Speaker
16. Speaker key/mute
17. Display/monitor
18. Camera and Camera control keys
19. Number keys and function keys
20. Credit card control keys
21. Fax control keys
22. Slot for scanning a credit/debit card
23. Speaker handset
24. Microphone on handset
25. Speaker phone key
26. CPU audio/video/digital processor
27. Memory
28. On/off key for radio
29. Housing apparatus
30. Function/number keys
31. Cradle
32. Transmission signal
33. Signal relay tower
34. Relayed transmission signal

1. A stationary non-mobile cellular telephone has a Base apparatus that receives and transmits signals to cellular telephone system-network. The stationary non-mobile cellular telephone base apparatus will house a cellular receiver, transmitter and antenna to eliminate radiation hazards to user. The Antenna might be attached to the body of the base to improve the signals.

2. The stationary non-mobile cellular telephone base apparatus of claim one can be desktop, wall mounted or vehicle mounted.

3. A handset is hardwired to the stationary non-mobile cellular telephone base apparatus of claim one and it has a microphone and a speaker. When the handset is not in use, it is placed in a cradle on the stationary non-mobile cellular telephone base apparatus of claim one.

4. A speaker button is on the stationary non mobile cellular telephone base apparatus of claim one, and a cellular telephone conversation can be done through speakers on the stationary non mobile telephone base apparatus of claim one.

5. Talking through the handset of claim three or through the speakers of claim four will completely eliminate any radiation hazard to the user.

6. The stationary non mobile cellular telephone base apparatus
Of claim one can be powered either by:
a) Plug to regular electric outlet.
b) Plug to regular electric outlet using volt transformer.
c) Regular battery, for back up.
d) Rechargeable battery, for back up.

7. The stationary non-mobile cellular telephone base apparatus of claim one will house a cellular receiver, transmitter and antenna to eliminate radiation hazards to user. The Antenna might be attached to the body of the base to improve the signals.

8. A keypad for entering data is either on the stationary non mobile cellular telephone base apparatus of claim one or on the handset of claim 3 The keypad of can be used to enter data and other order commands like all the telephone dialing buttons or features including but not limited to (numbers 0-9, alphabetical, * sign, # sign, redial, memory, program volume, speed dialing, hold, mute, ring volume, handset volume, flashing.

9. The stationary non-mobile cellular telephone may have a LCD or plasma display screen, capable of displaying data and videos.

10. The stationary non-mobile cellular telephone may have caller Identification features like, CID, directory, and display dial, select, and clear options.

11. The stationary non mobile cellular telephone may have a digital answering machine or old fashion answer machine integrated in it, with functions like (play, mail boxes, skip, delete, answer on, answer off)

12. The stationary non-mobile cellular telephone can have clock features (shows time) and alarm function.

13. The stationary non mobile cellular telephone may have a fax machine that may be incorporated, attached, built in, equipped with manual, automatic or both fax features to receive, send, store fax that require memory.

14. The stationary non mobile cellular telephone may have a radio incorporated, attached, built in, equipped with manual, automatic features to listen to AM/FM radio stations. It will have means to activate the radio and deactivate the telephone transmitter so that the speaker can be used to output broadcast radio, audio data to the user The stationary non mobile cellular telephone may have a credit card machine that may be incorporated, attached, built in, equipped with manual, automatic functions to do financial transactions.

15. The stationary non-mobile cellular telephone can be incorporated, attached to a desktop computer to allow instant cellular wireless communication with Internet providers.

16. The stationary non-mobile cellular phone can be equipped with a camera to send and receive pictures videos.

17. The stationary non-mobile cellular phone can be equipped with a printer, copier, and scanner to print incoming faxes, pictures and data.

18. The stationary non-mobile cellular phone can be equipped with anti-theft alarm banal; this is wirelessly monitors door alarms and motion detector equipments. The alarm will be activated by any unauthorized intrusions and dial the central monitoring station directly.

19. The stationary non-mobile cellular phone can be equipped with GPS
